(19) United States
(12) Patent Application Publication
(10) Pub. No.: US 2020/0123411 A1
(43) Pub. Date: Apr. 23, 2020

(54) BREAK-RESISTANT SOL-GEL COATINGS

(71) Applicant: MetaShield LLC, New York, NY (US)

(72) Inventor: Jacob M. Schliesser, St. George, UT (US)

(21) Appl. No.: 16/654,736

(22) Filed: Oct. 16, 2019

Related U.S. Application Data
(60) Provisional application No. 62/748,179, filed on Oct. 19, 2018.

(51) Int. Cl. C09D 183/08; C09D 183/06

(52) U.S. Cl. CPC C09D 183/08; C09D 183/06

(57) ABSTRACT

A sprayable coating composition is described that may improve the break strength of glass. The composition is capable of forming a cross-linked polysiloxane coating upon spray application to a substrate. The composition may include a polymerizable first silane having four reactive groups each independently selected from alkoxy, halogen or a combination thereof; one or more polymerizable second silane having three reactive groups each independently selected from alkoxy, halogen or a combination thereof; a polymerizable fluorosilane having from one to three reactive groups each independently selected from alkoxy, halogen or a combination thereof; a solvent; an acid; water; and a surfactant.

### CROSS-REFERENCE TO RELATED APPLICATION

A claim for the benefit of priority to the Oct. 19, 2018 filing date of U.S. Provisional Patent Application No. 62/748,179, titled Break-Resistant So-Gel Coatings (“the '179 Provisional Application”) is hereby made pursuant to 35 U.S.C. § 119(e). The entire disclosure of the '179 Provisional Application is hereby incorporated herein.

### TECHNICAL FIELD

The present disclosure relates generally to sol-gel coatings. More specifically, the present disclosure relates to protective sol-gel coatings for substrates, including, but not limited to, various types of glass. This disclosure also relates to the use of sol-gel coatings to protect substrates, including, but not limited to, the use of sol-gel coatings to increase the break strength of glass.

### BACKGROUND

Sol-gel processes include the preparation of solid, inorganic polymers or ceramics from solution through a transformation from liquid precursors to a sol and finally to a network structure called a “gel.” Sol-gel chemistry has received significant attention due to its simplicity and ability to reduce costs in the fabrication of thin films or monolithic ceramics. The majority of work done with sol-gel chemistry has involved silicon chemistry to produce silica-like materials, in particular films that typically range from a few nanometers to a few microns, which are useful in applications ranging from optics, catalysis, mechanical properties, corrosion resistance, sensors, and a plethora of other areas.

### SUMMARY

The coating compositions and processes disclosed herein are based on a sol-gel platform, meaning that they can be used in sol-gel processes to form coatings on substrates.

According to one aspect, the coating composition may form a cross-linked polysiloxane coating upon application to a substrate (e.g., by spraying the coating composition onto the substrate, etc.). The coating composition may include: a first silane that is polymerizable; a second silane that is polymerizable; a flurosilane that is polymerizable; a solvent; an acid; water; and a surfactant. The first silane may include four reactive groups, each selected from an alkoxy group, a halogen group, or a combination thereof. The second silane may include three reactive groups, each selected from an alkoxy group, a halogen group, or a combination thereof. The fluorosilane may include from one to three reactive groups, each selected from an alkoxy group, a halogen group, or a combination thereof.

In some embodiments, the coating composition may comprise a sprayable coating composition. The sprayable coating composition may be capable of forming a cross-linked polysiloxane coating upon spray application to a substrate. Such a sprayable coating composition may comprise: one or more first silanes with four reactive groups, each selected from an alkoxy group, a halogen group, or a combination thereof; one or more second silanes with three reactive groups, each selected from an alkoxy group, a halogen group, or a combination thereof a fluorosilane with from one to three reactive groups, each selected from an alkoxy group, a halogen group, or a combination thereof; a solvent; an acid; water; and a surfactant. The reactive groups of each first silane, each second silane, and the flurosilane may render the first silane(s), the second silane(s), and the flurosilane polymerizable.

In some configurations, the four reactive groups of the first silane may be alkoxy groups, and each of the four reactive groups may be selected from a methoxy group, an ethoxy group, a propoxy group, a butoxy group, and a hexoxy group. More specifically, the first silane may be selected from tetraethylorthosilicate (tetraethoxysilane or TEOS), tetrapropoxysilane, tetrabutoxysilane, and tetrahexoxysilane. Even more specifically, the first silane may be tetraethoxysilane. The second silane may be a methyltrialkoxysilane, an ethyltrialkoxysilane, or a combination thereof.

The three reactive groups of the second silane may be alkoxy groups, and each of the three reactive groups may be selected from a methoxy group, an ethoxy group, or a combination thereof. In some configurations, the second silane may include a non-reactive group, which may be selected from a methyl group or an ethyl group. For example, the second silane may be methyltriethoxysilane (MTEOS).

The fluorosilane of the coating composition may be a fluoroalkoxysilane. The one to three reactive groups of the fluorosilane may be alkoxy groups, and each of the alkoxy groups may be selected from a methoxy group, an ethoxy group, a propoxy group, a butoxy group, and a hexoxy group. In some configurations, the fluoroalkoxysilane has an unreactive perfluoro group having a carbon chain having from between 4 and 12 carbon atoms. For example, the fluorosilane may be (heptadecafluoro-1,1,2,2-tetrahydrodecyl)trimethoxysilane (1H,1H,2H,2H-Perfluorodecyltrimethoxysilane or HDFDTMS).

The coating composition may further comprise water in an amount sufficient to dilute the coating composition to a sprayable viscosity. In some configurations, the solvent may be acetone. In some configurations, the acid may be hydrochloric acid. In some configurations, the surfactant may be a polysiloxane. For example, the polysiloxane may be a polyether modified polysiloxane, such as a polyether modified polydimethylsiloxane.

The concentration of the first silane(s) may be from about 2% to about 18%, by weight, based on a weight of a total formulation of the coating composition. In some configurations, the concentration of the first silane(s) is from about 4%, by weight, based on a weight of the total formulation of the coating composition. The concentration of the second silane(s) may from about 0.5% to about 5%, by weight, based on a weight of a total formulation of the coating composition. In some configurations, the concentration of the second silane(s) may be about 1%, by weight, based on a weight of the total formulation of the coating composition. In some configurations, the concentration of the fluorosilane may be about 0.06%, by weight, based on a weight of the total formulation of the coating composition.

The concentration of the solvent may be from about 10% to about 45%, by weight, based on a weight of the total formulation of the coating composition. In some configurations, the concentration of the solvent is about 18%, by weight, based on a weight of the total formulation of the coating composition. In some configurations, the concentration of the acid may be from about 0.025% to about 0.055%, by weight, based on a weight of the total formulation of the coating composition. More specifically, the concentration of the acid may be about 0.03%, by weight, based on a weight of the total formulation of the coating composition. In some configurations, the concentration of the water is from about 60% to about 90%, by weight, based on a weight of the total formulation of the coating composition.

According to another aspect, the acid may be omitted from a coating composition and provided in a second composition, which may be mixed with the coating composition prior to use. In such an embodiment, the coating composition may include one or more first silanes, one or more second silanes, a flurosilane, and a solvent. Such a coating composition may also optionally include water and/or a surfactant. The second composition may include water, an acid, and a surfactant. The concentration of the water of the second composition may be about 72%, by weight, based on a weight of the total formulation of the entire coating composition. In some configurations, the concentration of the surfactant may be from about 0.02% to about 0.5%, by weight, based on a weight of the total formulation of the entire coating composition. For example, in some configurations the concentration of the surfactant is about 0.2%, by weight, based on a weight of the total formulation of the entire coating composition.

According to yet another aspect, a set of shelf stable compositions for subsequent combination to form a mixture capable of forming a cross-linked polysiloxane coating on a substrate in a sol-gel process may comprise a first composition, a second composition, and a third composition. The first composition may comprise: (1) one or more first silanes with four reactive groups, each selected from an alkoxy group, a halogen group, or a combination thereof; (2) one or more second silanes with three reactive groups, each selected from an alkoxy group, a halogen group, or a combination thereof; (3) a fluorosilane with from one to three reactive groups, each selected from an alkoxy group, a halogen group, or a combination thereof; and (4) a solvent. The second composition may comprise an acid and water. The third composition may comprise a surfactant and water. Each of the first composition, the second composition, and the third composition may be stored separately (e.g., in separate containers, etc.) and have a stable shelf life (e.g., a shelf life of at least 52 weeks, etc.). The combination of the first composition, the second composition, and the third composition may produce a smooth, uniform, wet film that dries without loss of smoothness and uniformity.

In some configurations, the four reactive groups of a first silane of the first composition may be alkoxy groups, with each of the four reactive groups being selected from a methoxy group, an ethoxy group, a propoxy group, a butoxy group, and a hexoxy group. Each first silane may be selected from tetraethoxysilane, tetrapropoxysilane, tetrabutoxysilane, and tetrahexoxysilane. In some configurations, tetraethoxysilane may be used as a first silane. In some configurations, each second silane may be a methyltrialkoxysilane, an ethyltrialkoxysilane, or a combination thereof. The three reactive groups of the second silane may be an alkoxy group, with each of the three reactive groups being selected from a methoxy group, an ethoxy group, or a combination thereof. A second silane may have a non-reactive group selected from a methyl group or an ethyl group. In some configurations, methyltriethoxysilane may be used as a second silane.

The fluorosilane of the first composition may be a fluoroalkoxysilane, such as a perfluorotrialkoxysilane. In some configurations, the one to three reactive groups of the fluorosilane may be alkoxy groups, with each of the alkoxy groups being selected from a methoxy group, an ethoxy group, a propoxy group, a butoxy group, and a hexoxy group. In some configurations, the fluoroalkoxysilane has an unreactive perfluoro group with a carbon chain having from 4 to 12 carbon atoms. For example, the fluorosilane may be (heptadecafluoro-1,1,2,2-tetrahydrodecyl)trimethoxysilane.

In some configurations, the solvent of the first composition of the set of shelf stable compositions may be acetone.

The concentration of first silane(s) in the first composition may be from about 2% to about 18%, by weight, based on a weight of the total formulation of the combined set of shelf stable compositions. In some configurations, the concentration of the first silane(s) may be from about 4%, by weight, based on a weight of the total formulation of the combined set of shelf stable compositions. The concentration of the second silane(s) may be from about 0.5% to about 5%, by weight, based on a weight of the total formulation of the combine set of shelf stable compositions. More specifically, the concentration of the second silane(s) may be about 1%, by weight, based on a weight of the total formulation of the combined set of shelf stable compositions. The perfluorosilanes used in the coating compositions may be present in a concentration ranging from about 0.005% to about 0.4%, by weight, of the final composition. More specifically, the range may be about 0.01% to about 0.2%, by weight, of the final composition. Even more specifically, the range may be about 0.05% to about 0.08%, by weight, of the final composition.

The concentration of the solvent of the first composition may be from about 10% to about 45%, by weight, based on a weight of the total formulation of the combined set of shelf stable compositions. In some configurations, the concentration of the solvent is about 18%, by weight, based on a weight of the total formulation of the combined set of shelf stable compositions.

The second composition of the set of shelf stable compositions may comprise water in an amount sufficient to dilute the combined first composition, second composition, and third composition, when combined, to be sprayable.

In some configurations, the acid of the second composition of the set of shelf stable compositions may be hydrochloric acid. In some configurations, the surfactant of the third composition of the set of shelf stable compositions may be a polysiloxane.

In some configurations, the polysiloxane may be a polyether modified polysiloxane, for example, a polyether modified polydimethylsiloxane.

The concentration of the acid of the second compositions of the set of shelf stable compositions may be from about 0.025% to about 0.055%, by weight, based on a weight of the total formulation of the combined set of shelf stable compositions. For example, the concentration of the acid may be 0.03%, by weight, based on a weight of the total formulation of the combined set of shelf stable compositions. The concentration of the water of the second composition may be from about 60% to about 90%, by weight, based on a weight of the total formulation of the combined set of shelf stable compositions. The concentration of the water of the second composition may be about 72%, by weight, based on a weight of the total formulation of the combined set of shelf stable compositions.

The concentration of the surfactant of the third composition of the set of shelf stable compositions may be from about 0.02% to about 0.5%, by weight, based on a weight of the total formulation of the combined set of shelf stable compositions. The concentration of the surfactant may be about 0.2%, by weight, based on a weight of the total formulation of the combined set of shelf stable compositions.

According to another aspect, methods for forming coating compositions are also described. A first composition may be made by mixing acetone, TEOS, MTEOS, and HDFDTMS. In some configurations, the molar ratios of TEOS:MTEOS:HDFDTMS are about 3:1:0.016. A second composition may be made by mixing water and HCl. The HCl may have a molarity of about 0.085 M.A third composition may be made by mixing water and a polyether modified polysiloxane. The polyether modified polysiloxane may comprise polyether modified polydimethylsiloxane. The weight percent of the polyether modified polysiloxane may be about 0.2%, by weight, based on a weight of the total formulation of the coating composition (e.g., the first composition, the second composition, and the third composition blended in appropriate proportions, etc.), or the final composition. The first composition and the second composition may be mixed for at least 20 minutes to form a mixture, and then the third component may be added to the mixture. In some configurations, the molar ratio of reactive alkoxy silane groups to water, Rw, in the final composition may be 0.5, the final composition may have a pH of about 2.0 to about 2.5 may be 0.5, and mixing of the first composition, the second composition, and, optionally, the third composition, may occur for at least 20 minutes to form the final composition.

The coating compositions can be augmented with various additives. The additives may impart a coating with impact resistance, scratch resistance, chemical resistivity, antireflection/forward light scattering properties, UV light blocking properties, amphiphilicity, etc., or combinations thereof. The sol-gel platform is an organic/inorganic hybrid that incorporates an epoxide binder to link the inorganic silica matrix. The additives may include metal, semiconducting, or insulating nanoparticles, organic polymers, and/or metal dopants.

### BRIEF DESCRIPTION OF THE DRAWINGS

In the drawings:

FIG. 1 is a table showing the formulations of various embodiments of coating compositions;

FIG. 2 is a table showing data of various physical properties of representative formulations of coating compositions;

FIG. 3 is a graph of data from ring-on-ring testing; and

FIG. 4 is a graph of data from pencil hardness testing.

### DETAILED DESCRIPTION

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, the term “about” modifying the quantity of a component or ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. The term “about,” when used in reference to the concentration of an ingredient of a composition, also encompasses concentration amounts that result in substantially similar functional properties of the overall composition. Whether or not modified by the term “about,” the claims include equivalents to the quantities.

Silanes

The coating compositions described herein may comprise organically substituted silanes. In some configurations, the composition may comprise one or more polymerizable first silanes having four reactive groups, each selected from an alkoxy group, a halogen group, or a combination thereof, and one or more polymerizable second silanes having three reactive groups, each selected from an alkoxy group, a halogen group, or a combination thereof. In some embodiments, the organically substituted silanes may be a C1-C3 alkyl substituted trialkoxy-silanes. For example, organically substituted silanes may be methyl trimethoxysilane, methyl triethoxysilane, ethyl trimethoxysilane, ethyl triethoxysilane, or propyl trimethoxysilane, propyl triethoxysilane. In some embodiments, the organically substituted silanes may be a trialkoxymethylsilane, such as trimethoxysilane or triethoxymethylsilane (methyl triethoxysilane of MTEOS).

In some embodiments, the organically substituted silanes may be a C1-C3 alkyl substituted tetraalkoxy-silanes. For example, organically substituted tetraalkoxysilanes may be tetraethyl orthosilicate (tetraethoxysilane or TEOS).

The silanes used in the coating compositions may be present in a concentration ranging from about 0.5% to about 20%, by weight of the coating composition. More specifically, the range may be about 1% to about 10%, by weight of the coating composition. Even more specifically, the range may be about 3% to about 5%, by weight of the coating composition.

Perfluorosilanes

The coating compositions described herein may also comprise a perfluorosilane. The perfluorosilane may be, for example, a polymerizable fluorosilane having from one to three reactive groups, each selected from an alkoxy group, a halogen group, or a combination thereof. In some embodiments, the perfluorosilane may be a C8-C12 perfluoroalkyl substituted trialkoxy-silane. Examples of suitable C8-C12 perfluoroalkyl substituted trialkoxy-silanes may include, for example, 1H,1H,2H,2H-Perfluorooctyltrimethoxysilane ((Tridecafluoro-1,1,2,2-tetrahydrodecyl)trimethoxysilane); 1H,1H,2H,2H-Perfluorooctyltriethoxysilane ((Tridecafluoro-1,1,2,2-tetrahydrodecyl)triethoxysilane); 1H,1H,2H,2H-Perfluorodecyltrimethoxysilane (HDFDTMS or (Heptadecafluoro-1,1,2,2-tetrahydrodecyl)trimethoxysilane); 1H,1H,2H,2H-Perfluorodecyltriethoxysilane ((Heptadecafluoro-1,1,2,2-tetrahydrodecyl)triethoxysilane); 1H,1H,2H,2H-Perfluorododecyltrimethoxysilane; and 1H,1H,2H,2H-Perfluorododecyltriethoxysilane. In some embodiments, the perfluorosilane may be H,1H,2H,2H-Perfluorodecyltrimethoxysilane (HDFDTMS or (Heptadecafluoro-1,1,2,2-tetrahydrodecyl)trimethoxysilane); (Pentafluorophenyl)triethoxysilane; or trichloro(3,3,3-trifluoropropyl)silane.

The perfluorosilanes used in the coating compositions may be present in a concentration ranging from about 0.005% to about 0.4%, by weight, of the final composition. More specifically, the range may be about 0.01% to about 0.2%, by weight, of the final composition. Even more specifically, the range may be about 0.05% to about 0.08%, by weight, of the final composition.

Solvents

The coating compositions disclosed herein may also include a solvent. Solvents used may include any suitable solvent compatible with the silanes and/or fluorosilanes of the coating compositions. Solvents may include polar solvents, such as alcohols. Alcohol solvents may include, for example, methanol, ethanol, n-propanol, n-butanol. Alternatively, suitable solvents may include polar, aprotic solvents (e.g., acetone), tetrahydrofuran (THF), dimethyl sulfoxide (DMSO), acetonitrile (MeCN), or alkyl acetates (e.g., methyl acetate, ethyl acetate, propyl acetate, or butyl acetate). In some embodiments, the solvent may be acetone.

The solvent used in the coating compositions described herein may be present in a concentration ranging from about 10% to about 45%, by weight, of the final composition. More specifically, the solvent may be present in a concentration ranging from about 15% to about 30%, by weight, of the final composition. Even more specifically, the concentration of the solvent may be about 18%, by weight, of the final composition.

Surfactants

The coating compositions described herein may also include any suitable surfactant compatible with the silanes of such coating compositions. Suitable surfactants may include, for example, polysiloxane surfactants. In some embodiments, the polysiloxane surfactant may be a polyether modified polysiloxane, such as a polyether modified polydimethylsiloxane. Polyether modified polydimethylsiloxane surfactants are commercially available as BYK-3760 (BYK-Chemie GMBH, Germany).

Generally, the surfactant of the coating compositions may be present in a concentration of about 0.02% to about 0.5%, by weight, based on the total weight of the final composition.

### Example 1

Sil 19.4.9.3

A set of shelf stable compositions for subsequent combination to form a sprayable mixture capable of use in a sol-gel process and of forming a cross-linked polysiloxane coating upon spray application to a substrate was made as follows:

First Composition:

| | |
|---|---|
| TEOS | 4.42% |
| MTEOS | 1.26% |
| HDFDTMS | 0.063% |
| Acetone | 17.7% |

Second Composition:

| | |
|---|---|
| HCl (37%) | 0.032% |
| H₂O | 3.82% |

Third Composition:

| | |
|---|---|
| BYK-3760 | 0.247% |
| H₂O | 72.5%, |

with all percentages comprising percentages, by weight, of the final coating composition, which is equal to the combined weights of the first composition, the second composition, and the third composition, when mixed in appropriate amounts.

The first composition was made by combining all chemicals into an inert plastic container (such as a polypropylene container) in the order: acetone, tetraethylorthosilicate (TEOS), methyltriethoxysilane (MTEOS), and (heptadecafluoro-1,1,2,2-tetrahydrodecyl)trimethoxysilane (HDFDTMS). The composition was mixed for 2-3 minutes until homogeneous.

The second composition was made by combining all chemicals into an inert container in the order: deionized water and hydrochloric acid. The composition was mixed for 2-3 minutes until homogeneous.

The third composition was made by mixing at a low to medium revolutions per minute (rpm), combining all chemicals into an inert container in the order: deionized water and BYK-3760. The composition was mixed for 2-3 minutes until homogeneous, taking care to not introduce air bubbles/foam.

The three compositions were separately stored in sealed plastic containers (such as polypropylene containers) and refrigerated, without freezing.

A sprayable polysiloxane coating composition was made by mixing the first composition and second composition in an inert plastic container for approximately 1 hour. While still mixing the mixture of the first composition and second composition, the third composition was added and mixed for several minutes until homogenized. Air bubbles were removed by letting the solution settle for a few minutes (or alternatively, by sonication).

Within about 2 hours of combining and mixing all three compositions, the final mixture was applied to a substrate (a soda lime glass slide with dimensions of 50 mm×75 mm×1 mm (i.e., a microscope slide)) at a wet film thickness of about 20 μm to about 90 μm to achieve an optimal dry film thickness of about 250 nm to about 1,000 nm. The mixture was spray coated onto the substrate at a pressure of 14 psi, at a rate of about 4 mL/min., from a distance of about 3 inches from the substrate.

The coating was dry to the touch within 3-5 minutes following spraying under ambient temperature conditions. The coating was fully cured within 24-48 hours.

### Example 2

Formula A1 (Sil 0.7.1)

An acetone-based coating composition was prepared having the following components:

| | |
|---|---|
| TEOS | 2.70% |
| MTEOS | 0.77% |
| HCl (37%) | 0.046% |
| H₂O | 2.33% |
| Acetone | 94.2% |

with all percentages comprising percentages, by weight, of the acetone based composition.

The coating composition exhibited the following properties: increase ring-on-ring (RoR) break strength of a soda lime glass slide with dimensions of 50 mm×75 mm×1 mm by 25-133% (break strength enhancement refers to the average percent increase in ring-on-ring break strength of a coated soda lime glass slide with dimensions of 50 mm×75 mm×1 mm over an uncoated soda lime glass slide with dimensions of 50 mm×75 mm×1 mm); pencil hardness of 3H-6H; nanoindentation hardness of 320-2870 MPa; abrasion with CS-10F, 600 g, 50 passes at 60 cycles per minute showed ΔHaze=2.56-6.02%; abrasion with #0000 steel wool, 500 g, 50 passes at 60 cycles per minute showed ΔHaze=0.37%.

This coating composition may be somewhat difficult to spray due to the high volatility of acetone. This coating composition may be dry to the touch within one to two minutes, depending on the thickness. The coating composition may have a smooth appearance, but may exhibit discolorations (“rainbows”).

### Example 3

Formula W1 (Sil 0.7.17)

A water-based coating composition was prepared having the following components:

Part a

| | |
|---|---|
| TEOS | 4.42% |
| MTEOS | 1.26% |
| HCl (37%) | 0.032% |
| H₂O | 3.82% |
| Acetone | 17.7% |

Part b

| | |
|---|---|
| H₂O | 72.5% |
| BYK-3760 | 0.248% |

with all percentages comprising percentages, by weight, of the water based composition.

This coating composition exhibited the following properties: increase ring-on-ring (RoR) break strength of a soda-lime glass slide that has dimensions of 50 mm×75 mm×1 mm by 67-96%; pencil hardness of 5H-10H; abrasion with CS-10F, 600 g, 50 passes at 60 cycles per minute removed coating; abrasion with #0000 steel wool, 500 g, 50 passes at 60 cycles per minute removed coating. This coating may be dry to the touch within several minutes (depending on the thickness).

### Example 4

Formula A8 (Sil 19.4.21)

An acetone-based coating composition with a perfluorosilane was prepared having the following components:

| | |
|---|---|
| TEOS | 9.49% |
| MTEOS | 2.71% |
| HDFDTMS | 0.135% |
| HCl (37%) | 0.069% |
| BYK-3760 | 0.095% |
| H₂O | 8.20% |
| Acetone | 79.3% |

with all percentages comprising percentages, by weight, of the acetone-based composition.

This coating composition exhibited the following properties: pencil hardness of 4H-10H; abrasion with #0000 steel wool, 500 g, 100 passes at 60 cycles per minute showed ΔHaze=1.09-5.53%; abrasion with CS-10F, 600 g, 50 passes at 60 cycles per minute showed ΔHaze=0.33-0.94%; increase ring-on-ring (RoR) break strength of a soda-lime glass slide having dimensions of 50 mm×75 mm×1 mm by about 120% to about 122%. This coating composition may be dry to the touch within a minute or two (depending on the thickness).

This coating may have some splatter or orange-peel texture.

### Example 5

Formula W6 (Sil 19.4.27)

A water-based coating composition with a perfluorosilane was prepared having the following components:

Part a

| | |
|---|---|
| TEOS | 4.41% |
| MTEOS | 1.26% |
| HDFDTMS | 0.063% |
| H₂O | 1.44% |
| Acetone | 17.6% |
| BYK-3760 | 0.247% |

Part b

| | |
|---|---|
| H₂O | 74.9% |

with all percentages comprising percentages, by weight, of the water-based composition.

This coating composition exhibited the following properties: pencil hardness of 8H; abrasion with #0000 steel wool, 500 g, 10 passes at 60 cycles per minute showed ΔHaze=2.22%; abrasion with CS-10F, 600 g, 50 passes at 60 cycles per minute showed ΔHaze=8.85%; increase ring-on-ring (RoR) break strength of a soda lime glass slide having dimensions of 50 mm×75 mm×1 mm by 98%.

### Discussion

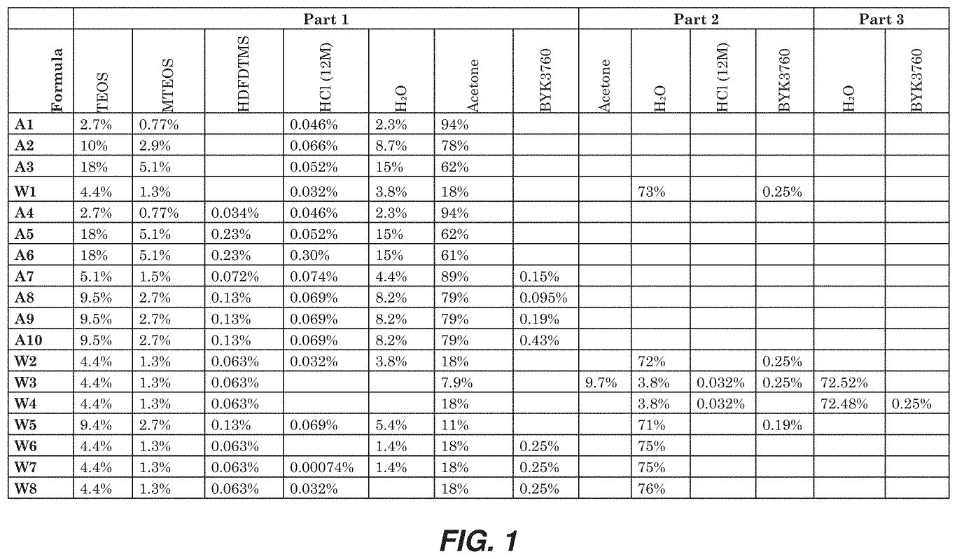

As described above, four general categories of coating compositions were successfully produced, including: (1) an acetone-based solution, (2) a water-based solution, (3) an acetone-based solution with perfluorosilane, and (4) a water-based solution with perfluorosilane. Representative formulas from these classes are described in FIG. 1 below, with concentration values given as a percentage of the weight of the final unreacted coating compositions. The tetraethylorthosilicate (TEOS), methyltriethoxysilane (MTEOS), acetone, HCl (12M), and other solvents were purchased from SigmaAldrich; the perfluorosilane 1H,1H,2H,2H-perfluorodecyltrimethoxysilane (HDFDTMS) was purchased from Gelest; and the surfactants were all acquired from BYK. All chemicals were used as acquired without further purification.

Acetone-Based Coating Compositions

The acetone-based coating compositions were prepared by mixing acetone, water, HCl, TEOS, and MTEOS for at least 30 minutes prior to application. The molar ratio of TEOS:MTEOS used was about 3:1. The molar ratio of reactive alkoxy silane groups to water, Rw, was about 0.5, meaning that there were twice as many water molecules as reaction sites in the solution, and the volume of HCl was selected such that the pH of the solution was set to about 2.0 to about 2.5. The amount of acetone was adjusted based on the application method. Several acetone-based coating compositions are given in FIG. 1 as A1-A3.

Water-Based Coating Compositions

The water-based coating compositions were prepared in two steps. The first step involved the hydrolysis of the silanes by mixing acetone, water, HCl, TEOS, and MTEOS for at least 30 minutes. The molar ratio of TEOS:MTEOS was about 3:1. The Rw for the initial hydrolysis step was about 0.5, and the pH was about 2.0 to about 2.5. After this step, a final larger volume of water and a surfactant were added to the solution to aid in the spray coating process. The amount of surfactant of the total solution was about 0.25%, which results in about 12% of the weight of the final dry film that comprised surfactant. One example of a water-based coating composition is given in FIG. 1 as W1.

Acetone-Based Coating Compositions with Perfluorosilane

Adding the perfluorosilane HDFDTMS to the acetone-based coating compositions significantly altered the liquid surface tension, making a surfactant necessary in acetone-based coating compositions where spray coating is the application method of choice. These acetone-based coating compositions were prepared by mixing acetone, water, HCl, TEOS, MTEOS, HDFDTMS, and a surfactant for at least 30 minutes prior to application. The molar ratio of TEOS:MTEOS:HDFDTMS was about 3:1:0.016, and Rw was about 0.5. The pH was about 2.0 to about 2.5. The concentration of the surfactant ranged from about 0 to about 0.5% of the liquid solution, which amount to about 0% to about 10% of the weight of the dry film that comprised surfactant. Several embodiments of acetone-based coating compositions with perfluorosilane are given in FIG. 1 as A4-A10.

Water-Based Coating Compositions with Perfluorosilane

Water-based coating compositions with perfluorosilane were prepared in multiple steps, similar to the water-based solutions without HDFDTMS in such a way that the chemical stability was optimized for shelf-life prior to mixing. In one configuration, the first part was prepared by mixing acetone, TEOS, MTEOS, and HDFDTMS. The second part was a simple mixture of water and HCl having a molarity of 0.085 M HCl. The third part consisted of water and the surfactant. The first step of synthesis involved the hydrolysis of the silanes by mixing the first part and the second part for at least 30 minutes. The third part was added just prior to application. The molar ratio of TEOS:MTEOS:HDFDTMS was about 3:1:0.016. The Rw for the initial hydrolysis at a pH of about 2.0 to about 2.5 was about 0.5. The amount of surfactant of the total coating composition was about 0.2%, of the weight of the total coating composition, which amounted to about 12% of the weight of the final dry film that comprised surfactant. Embodiments of water-based coating compositions with perfluorsilane are given in FIG. 1 as W2-W8.

Other Coating Compositions

A variety of other candidate coating compositions were made with other solvents, such as ethanol, propanol, and tetrahydrofuran. Different acids were used as catalysts, and various other surfactants were attempted. However, resulting coating compositions were found to either produce inferior coatings or coatings with the same properties; none were better than the four main groups of coating compositions discussed above.

Film Creation

Soda-lime glass slides with dimensions of 50 mm×75 mm×1 mm were used as substrates to be coated. These were cleaned for 3-5 minutes in an ultrasonication bath of about 2%, by weight, of a mild detergent diluted in water. Thin films were prepared from the above coating compositions, with the coating compositions optimized to be applied via spray coating. Typically, thinner films (on the order of about 200 nm or less) were achieved by dip-and-spin coating the substrates.

The coating compositions were applied using a nozzle with pressures in the range of about 5 psi to about 15 psi, a substrate-to-nozzle distance of about 7.5 cm to about 10 cm, and a fluid flow rate of about 4 mL/min. to about 8 mL/min. The nozzle was attached to a device built in-house that evenly sweeps the nozzle over the substrate area to produce a controlled, uniform coating.

Mechanical, Optical and Chemical Testing

Flexural Strength

Flexural strength of the substrates was tested on a Shimadzu Universal Testing Machine (UTM) equipped with a 10,000 N load cell. A ring-on-ring fixture was made in-house following ASTM C1499-15 to eliminate the effect of edge defects during testing. The load rate was fixed at 3 mm/min for all similar glass samples to achieve fracture within 10-15 seconds, thereby mitigating any effects of humidity and slow crack growth. The sample size for the uncoated 50 mm×75 mm×1 mm substrates was 30 samples. Coated samples were tested in batches of 5-30 samples. Coated samples were tested such that the coated side of the substrate was placed under tension, facing down in this setup. The force, in Newtons, required to break the glass was recorded.

Flexural test strength was also tested using the ball-drop impact test. These tests were performed by dropping a stainless steel ball of known mass from a known height onto a substrate that is clamped to the device base with a known pressure. Behind the substrate is a circular hole similar to the ring-on-ring setup, such that only the center of the substrate, not the edges, is placed under tension. Tests were performed on batches of 5-30 samples. Tests were typically performed by dropping the ball from a height somewhat lower than the break point of the uncoated substrate and increasing the height of each subsequent drop by about 2.5 cm to about 5 cm until the substrate broke. Break heights could be converted into energies via the equation E=mgh, where m is the ball mass, g is the acceleration due to gravity, and h is the height from which the ball was dropped.

Scratch Test

Scratch tests were performed using an Elcometer pencil hardness test, which uses pencils with hardnesses ranging from 10B-10H. Pencils were inserted into a trolley of known mass, such that the angle between the pencil tip and the surface to be tested was 45°. The pencil was pushed across the surface of the substrate (i.e., a surface of the uncoated substrates, the coated surfaces of the coated substrates), as detailed in standard test method for film hardness ASTM D3363-05. The pencil scratch hardness was taken as the hardness of the hardest pencil that would not produce a mark in the coating.

Abrasion Resistance

Films were tested for abrasion resistance using a linear Taber abrasion tester equipped with either a CS-10F abradant or #0000 steel wool pad. The total applied mass on the surface of the substrate using the CS-10F abradant and the steel wool were 600 g and 519 g, respectively. Two types of tests were performed: abrading a set number of cycles and checking for film permanence or measuring haze of the coatings every 5 cycles until the coating is observed to be removed based on a decrease of haze. The change in water contact angle and haze (Δhaze) were used to determine the extent of abrasion.

Surface Free Energy

The surface free energies (SFE) of the films were determined using a Kruss goniometer by applying about 2 to about μL of water or diiodomethane to the surface of the coating. An image may then be acquired of the resulting droplet using a sample stage with a magnification setup and back light, and the angle that the droplet formed relative to the substrate was determined using the goniometer's Advance software. The polar and disperse fractions of the SFE were determined by analyzing drops of water and diiodomethane.

Optical Ellipsometry

Film thickness and index of refraction (n) were determined with ellipsometry using a J.A. Woollam Alpha S.E. ellipsometer by analyzing the data with the CompleteEASE software. Coatings were made such that thicknesses all ranged from about 200 nm to about 1,000 nm.

UV-Vis Spectroscopy

Transmittance was measured on an Agilent Cary 100 UV-vis spectrophotometer.

FTIR Spectroscopy

Fourier transform infrared spectroscopy (FTIR) was performed with an Agilent Cary 610 spectrophotometer. These tests were mostly performed for solution age time studies.

### Results

Because the coating compositions react as soon as they come in contact with water, the age time of the solution was found to affect the results. Typically, properties were improved by coating when hydrolysis was maximized but condensation had only occurred minimally as measured by FTIR. Once applied, acetone-based solutions produced coatings that would dry within a minute or two, which may make the coating difficult to spray coat with a high-quality appearance since the solution may be prone to dry in the air, which may result in a powder coat. Water-based solutions became dry to the touch quickly, usually within about 5 minutes, which may make the solution easier to apply. Once applied, coatings require about 24 hours to about 48 hours to reach a useable degree of cure, though this time may be significantly shortened by applying a heat treatment. Coating thicknesses typically ranged from about 200 nm to about 1,000 nm. Thicker coatings tend to crack, especially upon heating.

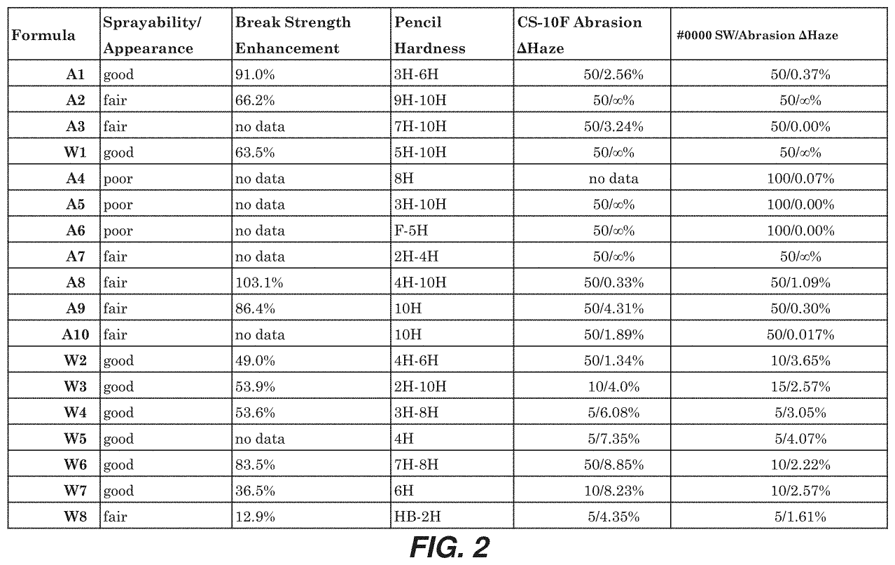

FIG. 2 provides data of various physical properties of representative formulations of coating compositions. Sprayability/appearance is a subjective measure of the quality of coatings produced by spraying; factors that affect sprayability and/or appearance include the wet solution not wetting the substrate well, solution pooling while drying, coatings that are hazy, thickness non-uniformities that can be seen by discolorations, and texture such as splatter or orange-peel. Break strength enhancement refers to the average percent increase in ring-on-ring break strength of coated soda lime glass slides with dimensions 50 mm×75 mm×1 mm over uncoated soda lime glass slides with dimensions of 50 mm×75 mm×1 mm, taken from all tests performed for each coating. Pencil hardness gives the range of pencil hardness values obtained from all experiments. CS-10F Abrasion ΔHaze and #0000 SW Abrasion ΔHaze values give the number of cycles to the left and before the slash; the change in haze from unabraded to abraded coatings is given to the right for each respective abradant. ΔHaze values of “∞ %” indicate that the coating was removed.

Flexural Strength

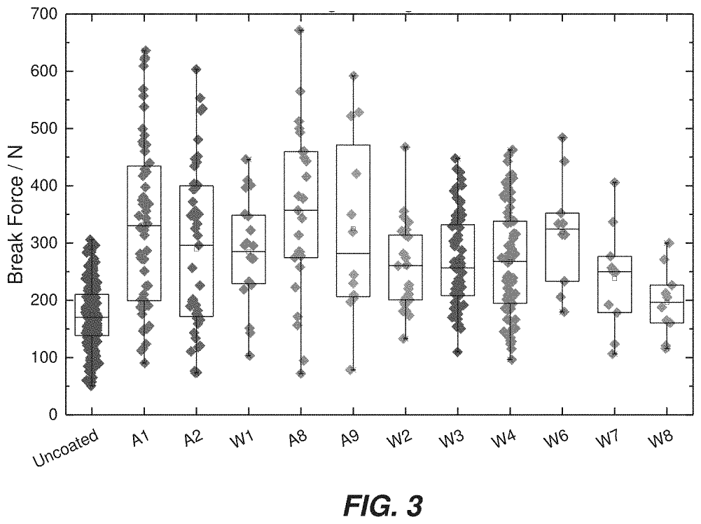

FIG. 3 provides data of ring-on-ring testing using a Universal Testing Machine (UTM) equipped with a 10,000 N load cell as described above (with a ring-on-ring fixture made in-house following ASTM C1499-15 to eliminate the effect of edge defects during testing). The force, in Newtons, required to break the glass was recorded.

Pencil Hardness

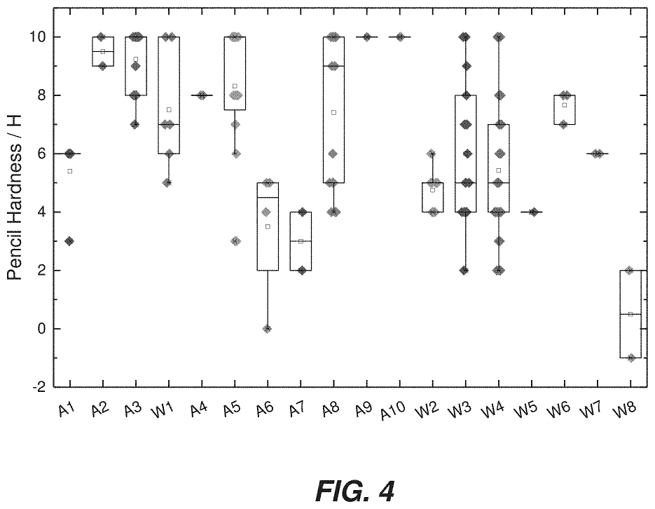

Data are shown in the box and whisker plot in FIG. 4. Note that several coating compositions only had one or two data points. The y-axis represents a function of hardness, where the number on the graph represents that hardness in H (i.e. 10=10H, 9=9H, etc.) except for 0 and −1, which correspond to F and HB, respectively.

Based on the above observations in FIGS. 1-4, it is seen that an organic/inorganic silica based thin film with various desirable properties has been successfully formed. The chemical, optical, and mechanical properties of films according to this disclosure have been proven using standard techniques and show that the product performs extremely well in its intended environments.

The various embodiments described above, including elements of the various embodiments described above, can be combined to provide further embodiments.

The above description has set out various features, functions, methods and other aspects of the disclosure. Time and further development may change the manner in which the various aspects are implemented. The claimed inventions may be implemented or embodied in other forms while still being within the concepts shown, described, and claimed herein. Also included are equivalents of the elements of the claims that can be made without departing from the scopes of concepts properly protected by the claims that follow.

What is claimed:

1. A sprayable coating composition capable of forming a cross-linked polysiloxane coating upon spray application to a substrate, comprising:
one or more polymerizable first silane having four reactive groups each independently selected from alkoxy, halogen or a combination thereof;
one or more polymerizable second silane having three reactive groups each independently selected from alkoxy, halogen or a combination thereof;
a polymerizable fluorosilane having from one to three reactive groups each independently selected from alkoxy, halogen or a combination thereof;
a solvent;
an acid;
water; and
a surfactant.

2. The coating composition according to claim 1, wherein the four reactive groups of the first silane are alkoxy and each of the four reactive groups is independently selected from methoxy, ethoxy, propoxy, butoxy and hexoxy.

3. The coating composition according to claim 1, wherein the first silane selected from tetraethoxysilane, tetrapropoxysilane, tetrabutoxysilane and tetrahexoxysilane.

4. The coating composition according to claim 1, wherein the three reactive groups of the second silane are alkoxy and each of the three reactive groups is independently selected from methoxy, ethoxy or a combination thereof.

5. The coating composition according to claim 1, wherein the fluorosilane is a fluoroalkoxysilane.

6. A set of shelf stable compositions for subsequent combination to form a sprayable sol-gel mixture capable of forming a cross-linked polysiloxane coating on a substrate, comprising:
a first composition comprising (1) one or more polymerizable first silane having four reactive groups each independently selected from alkoxy, halogen or a combination thereof, (2) one or more polymerizable second silane having three reactive groups each independently selected from alkoxy, halogen or a combination thereof, (3) a polymerizable fluorosilane having from one to three reactive groups each independently selected from alkoxy, halogen or a combination thereof, and (4) a solvent;
a second composition comprising an acid and water; and
a third composition comprising a surfactant;
wherein each of the first composition, second composition and third composition are disposed in separate containers and have a stable shelf life of at least 52 weeks; and
wherein the combination of the first composition, second composition and third composition produce a smooth uniform wet film that dries without loss of smoothness and uniformity.

7. The set of shelf stable compositions according to claim 6, wherein the four reactive groups of the first silane are alkoxy and each of the four reactive groups is independently selected from methoxy, ethoxy, propoxy, butoxy and hexoxy.

8. The set of shelf stable compositions according to claim 6, wherein the first silane selected from tetraethoxysilane, tetrapropoxysilane, tetrabutoxysilane and tetrahexoxysilane.

9. The set of shelf stable compositions according to claim 6, wherein the first silane is tetraethoxysilane.

10. The set of shelf stable compositions according to claim 6, wherein the second silane is a methyltrialkoxysilane, an ethyltrialkoxysilane, or a combination of two or more thereof.

11. The set of shelf stable compositions according to claim 6, wherein the three reactive groups of the second silane are alkoxy and each of the three reactive groups is independently selected from methoxy, ethoxy or a combination thereof.

12. The set of shelf stable compositions according to claim 6, wherein the second silane has a non-reactive group selected from methyl or ethyl.

13. The set of shelf stable compositions according to claim 6, wherein the second silane is methyltriethoxysilane.

14. The set of shelf stable compositions according to claim 6, wherein the fluorosilane is a fluoroalkoxysilane selected from a perfluorotrialkoxysilane.

15. The set of shelf stable compositions according to claim 6, wherein the fluorosilane comprises one to three active groups, and wherein the one to three reactive groups of the fluorosilane are alkoxy and each of the alkoxy groups is independently selected from methoxy, ethoxy, propoxy, butoxy and hexoxy.

16. The set of shelf stable compositions according to claim 6, wherein the surfactant comprises a polyether modified polysiloxane.

17. The set of shelf stable compositions according to claim 6, wherein the concentration of the first silane is from about 2% to about 18% by weight based on a total formulation.

18. The set of shelf stable compositions according to claim 1, wherein the concentration of the second silane is from about 0.5% to about 5% by weight based on a total formulation.

19. A method of forming a sprayable composition capable of forming a cross-linked polysiloxane coating upon spray application to a substrate, comprising:
making a first component by mixing acetone, triethoxysilane, methyl triethoxysilane, and 1H,1H,2H,2H-Perfluorodecyltrimethoxysilane;
making a second component by mixing water and HCl;
making a third component by mixing water and a polyether modified polysiloxane;
mixing the first component and the second component for at least 20 minutes to form a mixture; and
adding the third component to the mixture.

20. The method of claim 19, wherein molar ratios of triethoxysilane:methyl triethoxysilane: 1H,1H,2H,2H-Perfluorodecyltrimethoxysilane are about 3:1:0.016.
